(19) United States
(12) Patent Application Publication
(10) Pub. No.: US 2019/0359235 A1
(43) Pub. Date: Nov. 28, 2019

(54) ON-BOARD WIRELESS SYSTEM

(71) Applicant: MITSUBISHI ELECTRIC CORPORATION, Tokyo (JP)

(72) Inventors: Tetsuya AOYAMA, Tokyo (JP); Kazumasa SUZUKI, Tokyo (JP)

(73) Assignee: MITSUBISHI ELECTRIC CORPORATION, Tokyo (JP)

(21) Appl. No.: 16/470,517

(22) PCT Filed: Feb. 10, 2017
(86) PCT No.: PCT/JP2017/004934

§ 371 Date: Jun. 17, 2019

(51) Int. Cl. B61L 15/00; B61L 27/00; H04W 4/42; H04W 84/02; H04B 1/3822; H04W 72/08

(52) U.S. Cl. CPC B61L 15/0027; B61L 27/0005; H04W 72/08; H04W 84/02; H04B 1/3822; H04W 4/42

(57) ABSTRACT

An on-board wireless apparatus mounted on one vehicle constituting a train includes a wireless reception unit capable of receiving a wireless signal transmitted from a ground wireless apparatus installed on the ground, and a wireless transmission unit capable of transmitting a wireless signal to the ground wireless apparatus. In the on-board wireless apparatus, a parameter indicating reliability of wireless communication is different between wireless communication between the on-board wireless apparatus and the ground wireless apparatus, and wireless communication between another on-board wireless apparatus mounted on the same vehicle on which the on-board wireless apparatus is mounted and the ground wireless apparatus.

### FIELD

The present invention relates to an on-board wireless apparatus and a ground wireless apparatus in a wireless train control system that transmits and receives a control signal of a train, and the wireless train control system.

### BACKGROUND

A wireless train control system has attracted attention in which wireless communication is performed between an on-board wireless apparatus mounted on a train traveling along a track and a ground wireless apparatus installed near the track, and train control such as train operation control or speed control is performed on the basis of information transmitted by the wireless communication. As compared with a conventional train operation control method using a fixed block section, the wireless train control system is advantageous in terms of introduction cost and maintenance cost because a track circuit is unnecessary. In addition, because the wireless train control system can construct a flexible block section which is not bound by a fixed section, it is possible to increase operation density of trains, which is advantageous also in terms of operational cost.

In the wireless train control system, there is no provision in a wireless communication method between the ground wireless apparatus and the on-board wireless apparatus, but a system using radio waves of a 2.4 GHz band is mainstream. Regarding the 2.4 GHz radio band, Institute of Electrical and Electronic Engineers (IEEE) 802.11b/g can be exemplified. The 2.4 GHz band is also called industrial, scientific and medical (ISM) radio bands, and used for various applications including short-range wireless communication systems which are rapidly spreading in recent years and devices other than communication devices such as microwave ovens. As the short-range wireless communication systems, a wireless communication system using Bluetooth (registered trademark) or ZigBee (registered trademark) can be exemplified.

Because there is no regulation of areas of use of devices that use radio waves of the ISM radio bands, radio waves from multiple devices may interfere in the ISM radio bands. For this reason, securing reliability and availability of wireless communication is an issue in the wireless train control system using the ISM radio bands.

Patent Literature 1 discloses a method for enhancing reliability by providing a plurality of transmission paths between a ground wireless apparatus and a train in a wireless train control system. In the method described in Patent Literature 1, a wireless apparatus is mounted on each of a lead vehicle and a tail vehicle of one train consist, and thereby a plurality of transmission paths is provided between the ground wireless apparatus and the train. Then, in the method described in Patent Literature 1, one of the wireless apparatuses is selected depending on reception states in these wireless apparatuses. As a result, in the method described in Patent Literature 1, a transmission path with good communication quality among the transmission paths is selected.

### CITATION LIST

### Patent Literature

Patent Literature 1: Japanese Patent Application Laid-open No. 2004-56697

### SUMMARY

### Technical Problem

In the method disclosed in Patent Literature 1, a through cable is required to connect the wireless apparatuses installed in the lead vehicle and the tail vehicle. However, when an existing vehicle is adapted to the wireless train control system, there may be a case where the through cable cannot be used because there is no vacant through cable, for example, and in such a case, it is impossible to connect the wireless apparatuses. In addition, in order to additionally install a through cable for connecting wireless apparatuses installed in the lead vehicle and the tail vehicle, it is necessary to update a coupler connecting the vehicles, which is not realistic from a viewpoint of cost.

The present invention has been made in view of the above, and it is an object of the present invention to provide an on-board wireless apparatus capable of providing a plurality of transmission paths between a ground apparatus and a train without depending on a through cable that connects vehicles.

### Solution to Problem

In order to solve the above-described problems and to achieve the object, the on-board wireless apparatus according to the present invention is an on-board wireless apparatus mounted on one vehicle that constitutes a train, and includes a wireless reception unit capable of receiving a wireless signal transmitted from a ground wireless apparatus installed on the ground, and a wireless transmission unit capable of transmitting a wireless signal to the ground wireless apparatus. In the on-board wireless apparatus according to the present invention, a parameter indicating reliability of wireless communication is different between wireless communication between the on-board wireless apparatus and the ground wireless apparatus, and wireless communication between another on-board wireless apparatus mounted on the one vehicle and the ground wireless apparatus.

### Advantageous Effects of Invention

The on-board wireless apparatus according to the present invention achieves an effect that a plurality of transmission paths can be provided between a ground apparatus and a train without depending on a through cable that connects vehicles.

### BRIEF DESCRIPTION OF DRAWINGS

FIG. 1 is a diagram illustrating an example configuration of a wireless train control system according to a first embodiment.

FIG. 2 is a diagram illustrating an example configuration of a vehicle in the first embodiment.

FIG. 3 is a diagram illustrating an example configuration of a ground wireless apparatus of the first embodiment.

FIG. 4 is a diagram illustrating an example hardware configuration of the ground wireless apparatus of the first embodiment.

FIG. 5 is a diagram illustrating an example configuration of an on-board wireless apparatus of the first embodiment.

FIG. 6 is a diagram illustrating an example hardware configuration of the on-board wireless apparatus of the first embodiment.

FIG. 7 is a diagram illustrating a functional configuration of an on-board transmission apparatus of the first embodiment.

FIG. 8 is a diagram illustrating an example hardware configuration of the on-board transmission apparatus of the first embodiment.

FIG. 9 is a diagram illustrating an example configuration of a first table of the first embodiment.

FIG. 10 is a diagram illustrating an example configuration of a second table of the first embodiment.

FIG. 11 is a diagram illustrating an example of a transmission schedule in the ground wireless apparatuses and the on-board wireless apparatuses of the first embodiment.

FIG. 12 is a diagram illustrating an example of a transmission sequence in which train control information is transmitted from an on-board control apparatus to a ground control apparatus of the first embodiment.

FIG. 13 is a flowchart illustrating an example of a transmission processing procedure in the ground wireless apparatuses and the on-board wireless apparatuses of the first embodiment.

FIG. 14 is a flowchart illustrating an example of a reception processing procedure in the ground wireless apparatuses and the on-board wireless apparatuses of the first embodiment.

FIG. 15 is a diagram illustrating an example of a transmission sequence in which train control information is transmitted from the ground control apparatus to the on-board control apparatus of the first embodiment.

FIG. 16 is a sequence diagram illustrating an example of a procedure for connecting a wireless link from the on-board wireless apparatuses to the ground wireless apparatuses of a second embodiment.

### DESCRIPTION OF EMBODIMENTS

Hereinafter, an on-board wireless apparatus, a ground wireless apparatus, and a wireless train control system according to each embodiment of the present invention will be described in detail with reference to the drawings. The present invention is not limited to the embodiments.

### First Embodiment

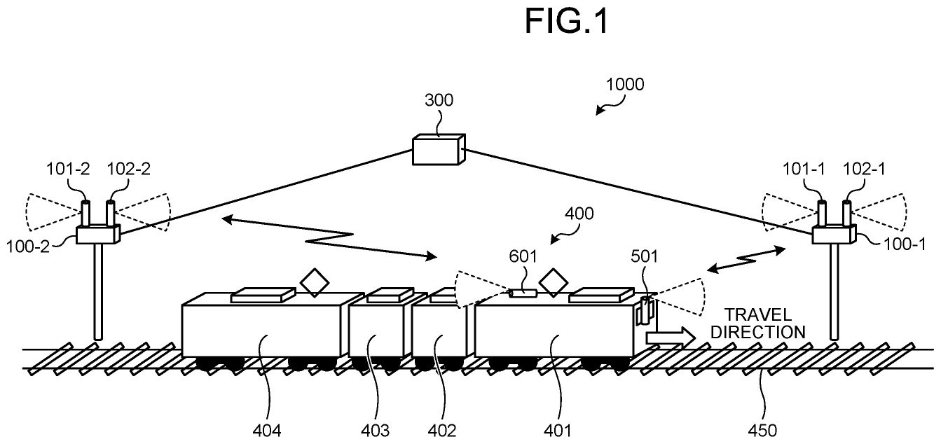

FIG. 1 is a diagram illustrating an example configuration of a wireless train control system according to a first embodiment of the present invention. As illustrated in FIG. 1, a wireless train control system 1000 according to the first embodiment includes on-board apparatuses mounted on a train 400 and ground apparatuses installed on the ground. The wireless train control system 1000 includes, as the ground apparatuses, a ground control apparatus 300 that controls the train 400 and ground wireless apparatuses 100-1 and 100-2 arranged along a track 450 illustrated in FIG. 1.

The ground wireless apparatus 100-1 is connected to antennas 101-1 and 102-1, and the ground wireless apparatus 100-2 is connected to antennas 101-2 and 102-2. The antennas 101-1, 102-1, 101-2, and 102-2 are directional antennas. Here, the antennas 101-1 and 101-2 generally orient a first direction that is a direction from the ground wireless apparatus 100-1 to the ground wireless apparatus 100-2, and the antennas 102-1 and 102-2 generally orient a second direction that is a direction from the ground wireless apparatus 100-2 to the ground wireless apparatus 100-1.

Hereinafter, the ground wireless apparatuses 100-1 and 100-2 will be described as ground wireless apparatuses 100 when indicated indiscriminately, the antennas 101-1 and 101-2 will be described as antennas 101 when indicated indiscriminately, the antennas 102-1 and 102-2 will be described as antennas 102 when indicated indiscriminately. Although FIG. 1 illustrates two ground wireless apparatuses 100, the number of ground wireless apparatuses 100 is not limited to that in the example of FIG. 1, and a plurality of the ground wireless apparatuses 100 is installed along a track. Each of the ground wireless apparatuses 100 is connected to the antenna 101 and the antenna 102.

The ground wireless apparatuses 100 are wiredly connected to the ground control apparatus 300. The ground control apparatus 300 generates train control information to be transmitted to the train 400 and transmits the train control information to the ground wireless apparatuses 100. The ground wireless apparatuses 100 transmit the train control information received from the train 400 to the ground control apparatus 300. The train control information is information transmitted and received between the ground control apparatus 300 and the train 400 in order to control the train 400. The train control information generated by the ground control apparatus 300 is, for example, information for performing operation control and speed control of the train 400.

The train 400 includes a vehicle 401 which is a lead vehicle, vehicles 402 and 403 which are intermediate vehicles, and a vehicle 404 which is a tail vehicle. The train 400 can travel on the track 450, and in the example illustrated in FIG. 1, a direction from the ground wireless apparatus 100-2 to the ground wireless apparatus 100-1 is a travel direction of the train 400. Although FIG. 1 illustrates one consist of the train 400, the ground control apparatus 300 can control a plurality of trains. In addition, although FIG. 1 illustrates an example in which the train 400 includes four vehicles, the number of vehicles constituting the train 400 is not limited thereto.

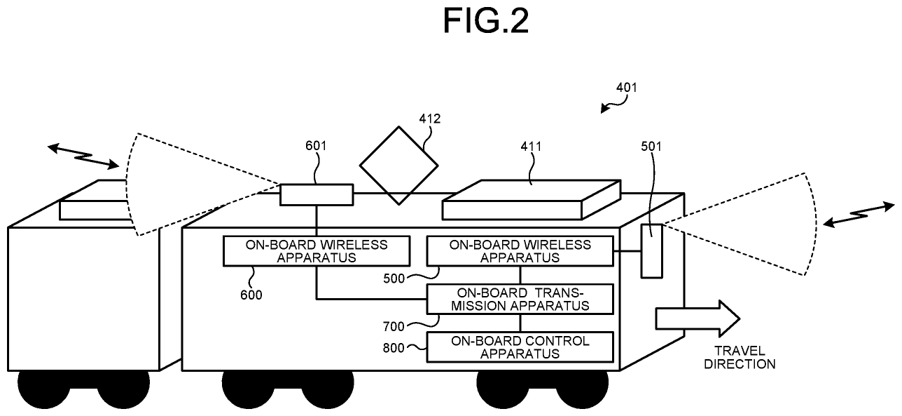

FIG. 2 is a diagram illustrating an example configuration of the vehicle 401 in the present embodiment. As illustrated in FIG. 2, the wireless train control system 1000 of the first embodiment includes, as on-board apparatuses, on-board wireless apparatuses 500 and 600, antennas 501 and 601, an on-board transmission apparatus 700, and an on-board control apparatus 800.

In addition, on a roof of the vehicle 401, an air conditioning machine (hereinafter abbreviated as an air conditioner) 411 and a pantograph 412 are mounted. Similarly, the air conditioner 411 is mounted on each of the vehicles 402 to 404. The air conditioner 411 and the pantograph 412 are examples of devices mounted on the vehicle, and the devices mounted on the vehicle are not limited thereto.

The on-board wireless apparatus 500, which is a first on-board wireless apparatus, is connected to the antenna 501 and performs wireless communication using the antenna 501. The on-board wireless apparatus 600, which is a second on-board wireless apparatus, is connected to the antenna 601 and performs wireless communication using the antenna 601. The antennas 501 and 601 are directional antennas. In the example illustrated in FIG. 2, the antenna 501 is arranged inside the vehicle 401 so as to orient the travel direction of the train 400. The antenna 501 is installed, for example, in front of a cab (not illustrated) in the vehicle 401. The antenna 601 is arranged on a roof of the train 400 so as to orient a direction opposite to the travel direction. The arrangement positions of the antennas 501 and 601 illustrated in FIG. 2 are merely examples, and the arrangement of the antennas 501 and 601 is not limited to the example illustrated in FIG. 2. The antenna 501 and the antenna 601 are different from each other in at least one of antenna type, antenna installation location, and antenna directionality. The antenna type indicates a type determined by a specification value of the antenna, and the specification value of the antenna includes an antenna gain. Therefore, the antennas 501 and 601 may have different antenna gains. Such a difference in antenna gains leads to a difference in reliabilities of wireless communication. The higher an antenna gain of an antenna, the higher the reliability of the communication using wireless communication with the antenna.

As illustrated in FIG. 2, the on-board wireless apparatus 500 and the on-board wireless apparatus 600 are wiredly connected to the on-board transmission apparatus 700. The on-board transmission apparatus 700 is an apparatus that presides wireless communication between the ground wireless apparatuses 100 and the on-board wireless apparatus 500 and the on-board wireless apparatus 600. In addition, the on-board transmission apparatus 700 is wiredly connected to the on-board control apparatus 800 that performs control of the train 400, such as brake control of the train 400. The on-board control apparatus 800 transmits train control information at predetermined fixed intervals. The train control information transmitted by the on-board control apparatus 800 is information indicating a state of the train 400, such as a speed of the train 400. The train control information is transmitted to the ground wireless apparatuses 100 via the on-board transmission apparatus 700 and the on-board wireless apparatus 500, and is also transmitted to the ground wireless apparatuses 100 via the on-board transmission apparatus 700 and the on-board wireless apparatus 600.

As illustrated in FIG. 2, the on-board wireless apparatus 500, the on-board wireless apparatus 600, the on-board transmission apparatus 700, and the on-board control apparatus 800 are installed within the same vehicle. For this reason, these apparatuses can be connected without using a through cable extending through vehicles. Because the on-board control apparatus 800 is generally provided in the lead vehicle, an example will be described here in which the on-board wireless apparatus 500, the on-board wireless apparatus 600, the on-board transmission apparatus 700, and the on-board control apparatus 800 are provided in the lead vehicle. However, the vehicle on which the on-board wireless apparatus 500, the on-board wireless apparatus 600, the on-board transmission apparatus 700, and the on-board control apparatus 800 are installed is not limited to the lead vehicle.

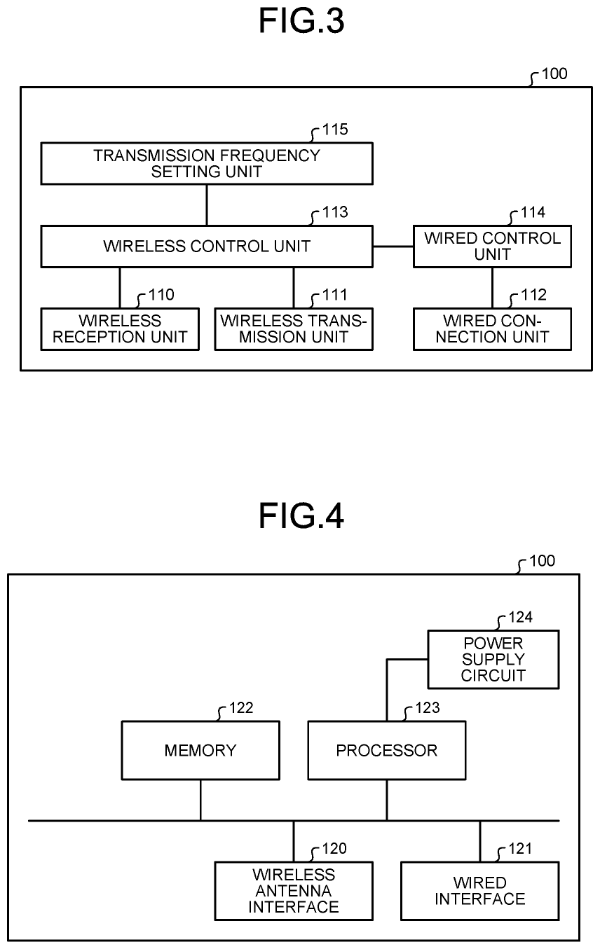

Next, an example configuration of each apparatus constituting the wireless train control system 1000 of the present embodiment will be described. FIG. 3 is a diagram illustrating an example configuration of the ground wireless apparatus 100 of the present embodiment. As illustrated in FIG. 3, the ground wireless apparatus 100 includes a wireless reception unit 110, a wireless transmission unit 111, a wired connection unit 112, a wireless control unit 113, a wired control unit 114, and a transmission frequency setting unit 115.

The wireless reception unit 110 performs a reception process on a wireless signal received by at least one of the antenna 101 and the antenna 102, and outputs the processed signal to the wireless control unit 113. The wireless signal includes train control information transmitted from the on-board control apparatus 800. The wireless control unit 113 passes the signal received from the wireless reception unit 110 to the wired control unit 114. In accordance with a predetermined transmission schedule to be described later, the wireless control unit 113 passes, to the wireless transmission unit 111, the train control information received from the wired control unit 114 and to be transmitted to the train 400. The wireless transmission unit 111 transmits the train control information received from the wireless control unit 113 to the on-board wireless apparatus 500 and the on-board wireless apparatus 600 of the train 400 via the antennas 101 and 102.

That is, the ground wireless apparatus 100 includes the wireless reception unit 110 capable of receiving wireless signals transmitted from the on-board wireless apparatus 500 and the on-board wireless apparatus 600 mounted on the vehicle 401, and the wireless transmission unit 111 capable of transmitting wireless signals to the on-board wireless apparatus 500 and the on-board wireless apparatus 600.

The wired control unit 114 transmits the signal received from the wireless control unit 113 to the ground control apparatus 300 via the wired connection unit 112. In addition, the wired control unit 114 passes, to the wireless control unit 113, the train control information received from the ground control apparatus 300 via the wired connection unit 112 and to be transmitted to the train 400. The wired connection unit 112 transmits the train control information received from the wired control unit 114 to the ground control apparatus 300, and passes, to the wired control unit 114, the train control information received from the ground control apparatus 300 and to be transmitted to the train 400. The transmission frequency setting unit 115 determines the number of repeated transmissions of the train control information in the same frame. Details of an operation of the transmission frequency setting unit 115 will be described later.

FIG. 4 is a diagram illustrating an example hardware configuration of the ground wireless apparatus 100. As illustrated in FIG. 4, the ground wireless apparatus 100 includes a wireless antenna interface 120, a wired interface 121, a memory 122, a processor 123, and a power supply circuit 124. The wireless antenna interface 120 is a communication circuit that is connected to the antenna 101 and the antenna 102 and performs a wireless signal process. The wired interface 121 is a circuit that performs a communication process depending on a communication line that connects the ground control apparatus 300 and the ground wireless apparatus 100. The power supply circuit 124 is a circuit that supplies power to each unit of the ground wireless apparatus 100.

The wireless reception unit 110 and the wireless transmission unit 111 illustrated in FIG. 3 are realized by the wireless antenna interface 120 illustrated in FIG. 4, and the wired connection unit 112 illustrated in FIG. 3 is realized by the wired interface 121 illustrated in FIG. 4. The wireless control unit 113, the wired control unit 114, and the transmission frequency setting unit 115 illustrated in FIG. 3 are realized by the processor 123 and the memory 122 illustrated in FIG. 4. The processor 123 and the memory 122 can also be called processing circuits. The wireless control unit 113, the wired control unit 114, and the transmission frequency setting unit 115 are realized by the processor 123 executing a program stored in the memory 122. The memory 122 is used also as a storage area when the program is executed by the processor 123.

The processor is a central processing unit (CPU), a microprocessor, or the like. The memory corresponds to a nonvolatile or volatile semiconductor memory such as a random access memory (RAM), a read only memory (ROM), or a flash memory, or a magnetic disk, or the like.

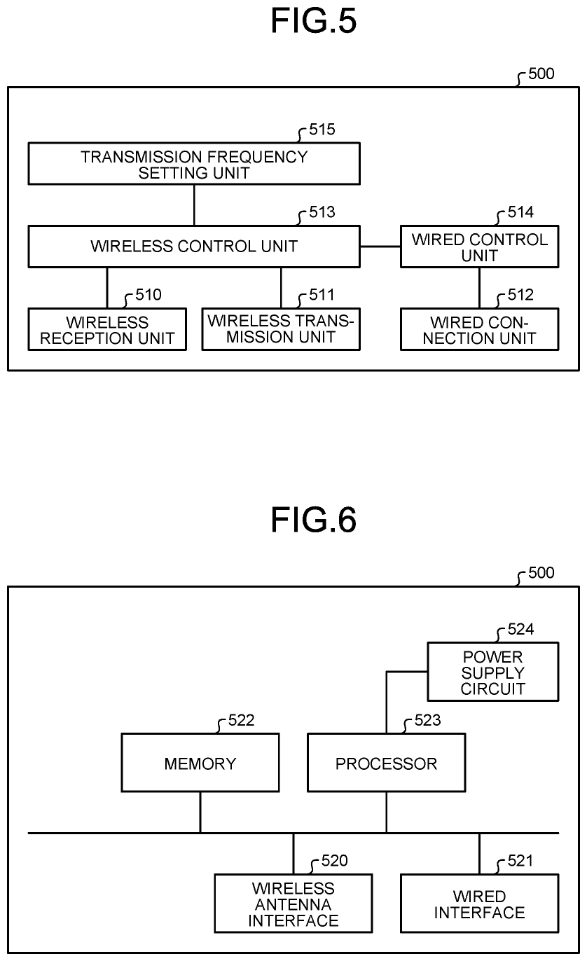

FIG. 5 is a diagram illustrating an example configuration of the on-board wireless apparatus 500. As illustrated in FIG. 5, the on-board wireless apparatus 500 includes a wireless reception unit 510, a wireless transmission unit 511, a wired connection unit 512, a wireless control unit 513, a wired control unit 514, and a transmission frequency setting unit 515.

The wireless reception unit 510 performs a reception process on wireless signals received by the antenna 501, and outputs the processed signals to the wireless control unit 513. The wireless signals include control signals received from the ground wireless apparatuses 100. The wireless control unit 513 passes the signals received from the wireless reception unit 510 to the wired control unit 514. In accordance with a predetermined transmission schedule described later, the wireless control unit 513 passes the train control information received from the wired control unit 514 to the wireless transmission unit 511. The wireless transmission unit 511 transmits the train control information received from the wireless control unit 513 to the ground wireless apparatuses 100 via the antenna 501.

The wired control unit 514 transmits the signal received from the wireless control unit 513 to the on-board transmission apparatus 700 via the wired connection unit 512. In addition, the wired control unit 514 passes the train control information received from the on-board transmission apparatus 700 via the wired connection unit 512 to the wireless control unit 513. The wired connection unit 512 transmits the signal received from the wired control unit 514 to the on-board transmission apparatus 700, and passes the train control information received from the on-board transmission apparatus 700 to the wired control unit 514. The transmission frequency setting unit 515 determines the number of repeated transmissions of the train control information in the same frame. Details of an operation of the transmission frequency setting unit 515 will be described later.

FIG. 6 is a diagram illustrating an example hardware configuration of the on-board wireless apparatus 500. As illustrated in FIG. 6, the on-board wireless apparatus 500 includes a wireless antenna interface 520, a wired interface 521, a memory 522, a processor 523, and a power supply circuit 524. The wireless antenna interface 520 is a communication circuit that is connected to the antenna 501 and performs a wireless signal process. The wired interface 521 is a circuit that communicates with the on-board transmission apparatus 700. The power supply circuit 524 is a circuit that supplies power to each unit of the on-board wireless apparatus 500.

The wireless reception unit 510 and the wireless transmission unit 511 illustrated in FIG. 5 are realized by the wireless antenna interface 520 illustrated in FIG. 6, and the wired connection unit 512 illustrated in FIG. 5 is realized by the wired interface 521 illustrated in FIG. 6. The wireless control unit 513, the wired control unit 514, and the transmission frequency setting unit 515 illustrated in FIG. 5 are realized by the processor 523 and the memory 522 illustrated in FIG. 5. The processor 523 and the memory 522 can also be called processing circuits. The wireless control unit 513, the wired control unit 514, and the transmission frequency setting unit 515 are realized by the processor 523 executing a program stored in the memory 522. The memory 522 is used also as a storage area when the program is executed by the processor 523.

Because a functional configuration and a hardware configuration of the on-board wireless apparatus 600 are similar to those of the on-board wireless apparatus 500 except that the antenna to be connected is different, descriptions of the functional configuration and the hardware configuration of the on-board wireless apparatus 600 will be omitted.

As described above, the on-board wireless apparatus 500 is an on-board wireless apparatus mounted on the vehicle 401, and includes the wireless reception unit 510 capable of receiving wireless signals transmitted from the ground wireless apparatuses 100 installed on the ground, and the wireless transmission unit 511 capable of transmitting wireless signals to the ground wireless apparatuses 100. The vehicle 401 is an example of one vehicle constituting the train 400. In the on-board wireless apparatus 500, a parameter indicating reliability of wireless communication is different between wireless communication between the on-board wireless apparatus 500 and the ground wireless apparatuses 100, and wireless communication between the on-board wireless apparatus 600 which is another on-board wireless apparatus mounted on the vehicle 401 and the ground wireless apparatuses 100. The on-board wireless apparatus 600 has a configuration similar to the on-board wireless apparatus 500, and for the on-board wireless apparatus 600, another on-board wireless apparatus mounted on the vehicle 401 is the on-board wireless apparatus 500.

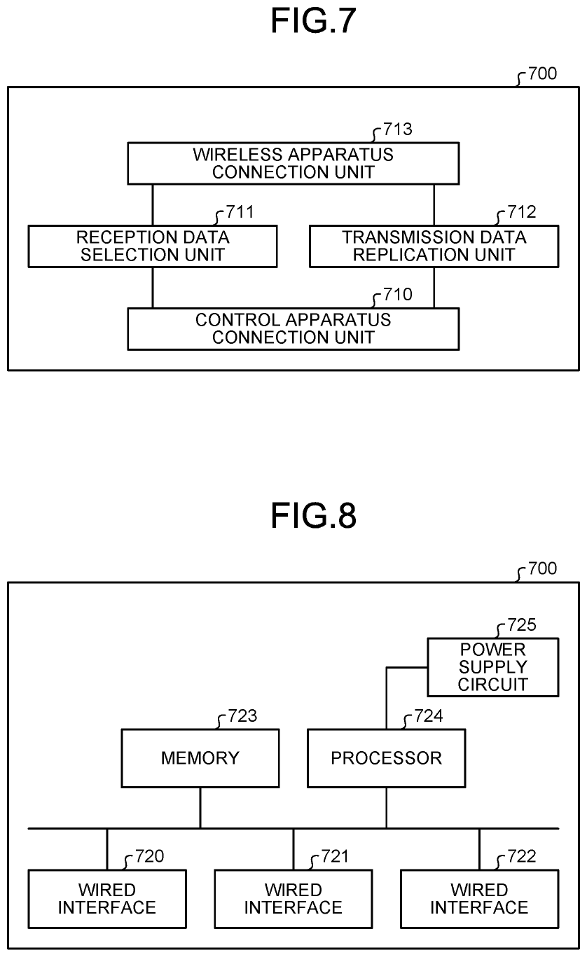

FIG. 7 is a diagram illustrating a functional configuration of the on-board transmission apparatus 700. As illustrated in FIG. 7, the on-board transmission apparatus 700 includes a control apparatus connection unit 710, a reception data selection unit 711, a transmission data replication unit 712, and a wireless apparatus connection unit 713. The control apparatus connection unit 710 receives train control information from the on-board control apparatus 800, and outputs the train control information to the transmission data replication unit 712. In addition, the control apparatus connection unit 710 transmits train control information received from the reception data selection unit 711 to the on-board control apparatus 800. When the train control information received from the wireless apparatus connection unit 713, that is, the train control information as reception data received from the on-board wireless apparatus 500 or the on-board wireless apparatus 600, is identical with data received in the past, the reception data selection unit 711 discards the reception data, and when the reception data is not identical with data received in the past, the reception data selection unit 711 outputs the reception data to the control apparatus connection unit 710.

The wireless apparatus connection unit 713 outputs the reception data received from the on-board wireless apparatus 500 and the data received from the on-board wireless apparatus 600 to the reception data selection unit 711. In addition, the wireless apparatus connection unit 713 transmits replicated data received from the transmission data replication unit 712, that is, replicated train control information to the on-board wireless apparatus 500 and the on-board wireless apparatus 600. The transmission data replication unit 712 replicates the train control information received from the control apparatus connection unit 710 and outputs the replicated train control information to the transmission data replication unit 712.

FIG. 8 is a diagram illustrating an example hardware configuration of the on-board transmission apparatus 700. As illustrated in FIG. 8, the on-board transmission apparatus 700 includes wired interfaces 720 to 722, a memory 723, a processor 724, and a power supply circuit 725.

The wired interface 720 is a circuit that communicates with the on-board wireless apparatus 500, and the wired interface 721 is a circuit that communicates with the on-board wireless apparatus 600. The wired interface 722 is a circuit that communicates with the on-board control apparatus 800. The power supply circuit 725 is a circuit that supplies power to each unit of the on-board transmission apparatus 700.

The wireless apparatus connection unit 713 illustrated in FIG. 7 is realized by the wired interface 720 and the wired interface 721 illustrated in FIG. 8, and the control apparatus connection unit 710 illustrated in FIG. 7 is realized by the wired interface 722 illustrated in FIG. 8. The reception data selection unit 711 and the transmission data replication unit 712 illustrated in FIG. 7 are realized by the processor 724 and the memory 723 illustrated in FIG. 8. The processor 724 and the memory 723 can also be called processing circuits. The reception data selection unit 711 and the transmission data replication unit 712 are realized by the processor 724 executing a program stored in the memory 723. The memory 723 is used also as a storage area when the program is executed by the processor 724.

Next, an operation of the present embodiment will be described. In the present embodiment in which apparatuses are mounted on the same vehicle, the reliability of wireless communication is different between a case of using one of two antennas mounted on the same vehicle in the train 400, and a case of using another thereof. That is, a parameter indicating reliability of wireless communication is different between wireless communication between the on-board wireless apparatus 500 and the ground wireless apparatuses 100, and wireless communication between the on-board wireless apparatus 600 and the ground wireless apparatuses 100. The parameter indicating reliability of wireless communication is, for example, one of antenna gain, antenna installation location, and antenna directionality. For example, by making antenna gains of the antennas 501 and 601 different from each other, reliabilities of wireless communication using the antennas 501 and 601 can be made different from each other. In addition, by making at least one of the installation locations and orientation directions of the antennas different from each other, the reliabilities of wireless communication using the antennas can be made different from each other. For example, regarding a case where an antenna is installed within the vehicle, that is, inside the vehicle, and a case where an antenna is installed on the roof, a shielding object is different therebetween, and thus, the reliability of wireless communication is different therebetween. In addition, regarding a case where an antenna is installed on the roof of the lead vehicle and orients a forward direction and a case where such an antenna orients a rearward direction, there are more shielding objects in the case of orienting the rearward direction due to presence of other vehicles, and thus radio wave signals weaken. Thus, the reliability of wireless communication varies depending also on antenna orientation directions.

In the present embodiment, when the reliabilities of wireless communication using the antennas are different from each other as described above, the number of times identical data is transmitted, that is, the number of repeated transmissions is determined depending on the reliabilities. The number of repeated transmissions is the number of duplicated data transmissions. In the present embodiment, the number of repeated transmissions is determined on the basis of antenna information including at least one of antenna type, antenna installation location, and antenna directionality. In the following, an example will be described in which the antenna information is the antenna installation location and the antenna directionality, but it is satisfactory as long as the antenna information includes at least one of the antenna type, the antenna installation location, and the antenna directionality.

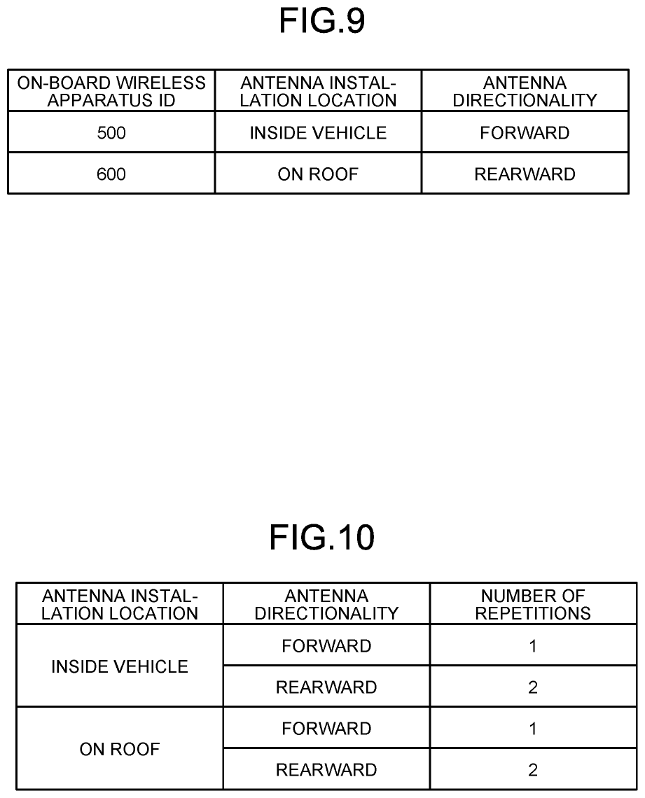

In the present embodiment, each of the transmission frequency setting units of the ground wireless apparatuses 100 and the on-board wireless apparatuses 500 and 600 stores, as a first table, antenna information on an antenna connected to the on-board wireless apparatus corresponding thereto. Here, the antenna information is the antenna installation location and the antenna directionality as described above, and the antenna information is hereinafter also referred to as antenna attachment information. FIG. 9 is a diagram illustrating an example configuration of the first table. As illustrated in FIG. 9, the first table includes an on-board wireless apparatus identifier (ID) which is identification information of an on-board wireless apparatus, an antenna installation location, and antenna directionality. The antenna installation location is information indicating where in the vehicle, antennas, to which the on-board wireless apparatuses are connected, are installed. The antenna directionality is information indicating orientation directions of antennas to which the on-board wireless apparatuses are connected. In the example illustrated in FIG. 9, the on-board wireless apparatus ID of the on-board wireless apparatus 500 is 500 and the on-board wireless apparatus ID of the on-board wireless apparatus 600 is 600.

As described with reference to FIG. 2, the antenna 501 connected to the on-board wireless apparatus 500 is installed inside the vehicle and orients the travel direction of the train 400, that is, the forward direction, so that the antenna attachment information corresponding to the on-board wireless apparatus ID 500 is such that the antenna installation location is the inside of the vehicle and the antenna directionality is forward. In addition, the antenna attachment information corresponding to the on-board wireless apparatus ID 600 is such that the antenna installation location is on the roof and the antenna directionality is rearward.

Each of the transmission frequency setting units of the ground wireless apparatuses 100 and the on-board wireless apparatuses 500 and 600 stores, as a second table, information indicating correspondence between the antenna attachment information and the number of repetitions. FIG. 10 is a diagram illustrating an example configuration of the second table. As illustrated in FIG. 10, the second table includes a combination of the antenna installation location and the antenna directionality, and the number of repetitions. The number of repetitions indicates the number of transmissions of the identical data when transmission is performed in each of the ground wireless apparatuses 100 to the corresponding antenna. When the number of repetitions is one, the repetition is not actually performed. The first table and the second table are set in advance to each ground wireless apparatus 100, for example, by an operator. When there is a change in an installation position of an antenna connected to the on-board wireless apparatus, addition of the on-board wireless apparatus and the antenna, or the like, the first table and the second table are updated by, for example, the operator. In the second table illustrated in FIG. 10, the number of repetitions is larger in a case where the antenna orients the rearward direction than in a case where the antenna orients the forward direction. The reason therefor is as follows. As illustrated in FIG. 2, the present embodiment is on the basis of the premise that each antenna is mounted on the lead vehicle. Therefore, when the antenna is installed at a rear portion, the intermediate vehicles and the tail vehicle, as well as individual devices mounted on the intermediate vehicles and the tail vehicle act as obstacles, and consequently, there is a possibility that communication quality deteriorates as compared with a case where the antenna is installed at a front portion. The second table illustrated in FIG. 9 is merely an example, and there is no limitation thereto. It is satisfactory as long as the number of repetitions is set on the basis of the installation location and the directionality of each antenna and an assumed radio wave environment.

Each of the transmission frequency setting units of the ground wireless apparatuses 100 and the on-board wireless apparatuses 500 and 600 determines the number of repeated transmissions by using the first table and the second table, and notifies each of the wireless control units thereof. Each of the wireless control units of the ground wireless apparatuses 100 and the on-board wireless apparatuses 500 and 600 performs transmission scheduling on the basis of the number of repetitions.

On the assumption of the states illustrated in FIGS. 1 and 2, it is assumed that pieces of information illustrated in FIGS. 9 and 10 are stored in the first table and the second table, respectively. In such a case, the on-board wireless apparatus 500 sets the number of repetitions to one using the ID of the on-board wireless apparatus 500, the first table, and the second table. The on-board wireless apparatus 600 sets the number of repetitions to two using the ID of the on-board wireless apparatus 600, the first table, and the second table. In the state illustrated in FIG. 1, the on-board wireless apparatus 500 performs wireless communication with the ground wireless apparatus 100-1, and the on-board wireless apparatus 600 performs wireless communication with the ground wireless apparatus 100-2. Therefore, the ground wireless apparatus 100-1 acquires a transmission ID of a source included in a wireless signal received from the on-board wireless apparatus 500, that is, the ID of the on-board wireless apparatus 500, and sets the number of repetitions to one using the acquired ID, the first table, and the second table. Similarly, the ground wireless apparatus 100-2 acquires a transmission ID of a source included in a wireless signal received from the on-board wireless apparatus 600, that is, the ID of the on-board wireless apparatus 600, and sets the number of repetitions to two using the acquired ID, the first table, and the second table.

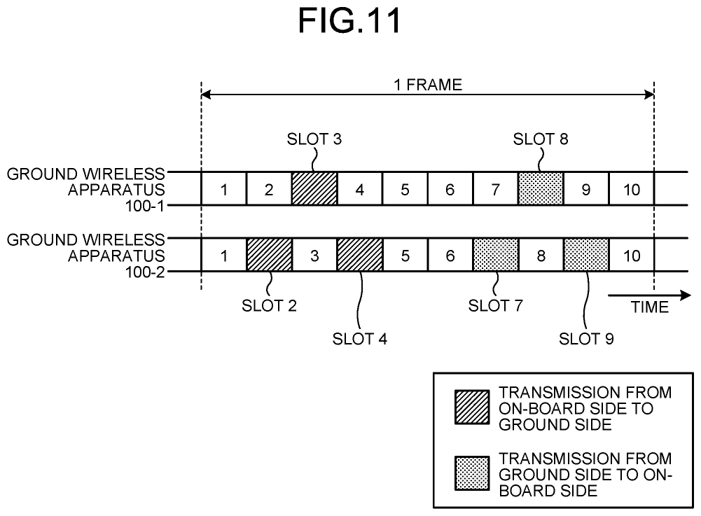

FIG. 11 is a diagram illustrating an example of a transmission schedule in the ground wireless apparatuses 100 and the on-board wireless apparatuses 500 and 600. In the example illustrated in FIG. 11, time zones of transmission from an on-board side, that is, from the on-board wireless apparatuses 500 and 600 to a ground side, that is, the ground wireless apparatuses 100, and those of transmission from the ground side to the on-board side are determined for each of the ground wireless apparatuses 100. In the example illustrated in FIG. 11, one frame as a unit of communication is divided into 10 time slots from slot 1 to slot 10. One slot is a minimum unit of time allocated for transmission. In order to avoid mutual interference between adjacent ground wireless apparatuses 100, separate communication time zones or frequency channels may be employed. In the example of FIG. 11, as an example of employing the separate communication time zones, it is assumed that available time slots in one frame are determined in advance for each of the ground wireless apparatuses 100-1 and 100-2 so as to prevent communication time zones for the ground wireless apparatuses 100-1 and 100-2 from overlapping each other. As the available time slots, time slots are determined which are available, for example, in a connection procedure for starting wireless communication between the ground wireless apparatuses 100 and the on-board wireless apparatuses 500 and 600. Here, it is assumed that the ground wireless apparatus 100-1 can use slots 1, 3, and 5 for transmission from the ground side to the on-board side, and slots 8 and 10 for transmission from the on-board side to the ground side. In addition, it is assumed that the ground wireless apparatus 100-2 can use slots 2, 4, and 6 for transmission from the ground side to the on-board side, and slots 7 and 9 for transmission from the on-board side to the ground side. Each of the ground wireless apparatuses 100 transmits available slots corresponding thereto to the on-board wireless apparatus 500 and 600.

As described above, the ground wireless apparatus 100-1 determines that the number of repetitions corresponding to the on-board wireless apparatus 500 is one. In the example illustrated in FIG. 11, the ground wireless apparatus 100-1 performs transmission scheduling so as to select slot 3 from among the slots available for transmission to the on-board wireless apparatus 500. Any method may be used as a method of selecting slots to be used for communication from available slots. In addition, the number of repetitions corresponding to the on-board wireless apparatus 500 is one, and the on-board wireless apparatus 500 performs transmission scheduling so as to select slot 8 from among the slots available for transmission to the ground wireless apparatus 100-1.

On the other hand, the ground wireless apparatus 100-2 determines that the number of repetitions corresponding to the on-board wireless apparatus 600 is two, as described above. In the example illustrated in FIG. 11, the ground wireless apparatus 100-2 performs transmission scheduling so as to select slots 2 and 4 from among the slots available for transmission to the on-board wireless apparatus 600. In addition, the number of repetitions corresponding to the on-board wireless apparatus 600 is two, and the on-board wireless apparatus 600 performs transmission scheduling so as to select slots 7 and 9 from among the slots available for transmission to the ground wireless apparatus 100-2.

The method of selecting a slot to be used for transmission illustrated in FIG. 11 is merely an example, and the number of slots constituting one frame, the method of allocating a slot available for communication in each ground wireless apparatus, and the like, are not limited to the examples illustrated in FIG. 11.

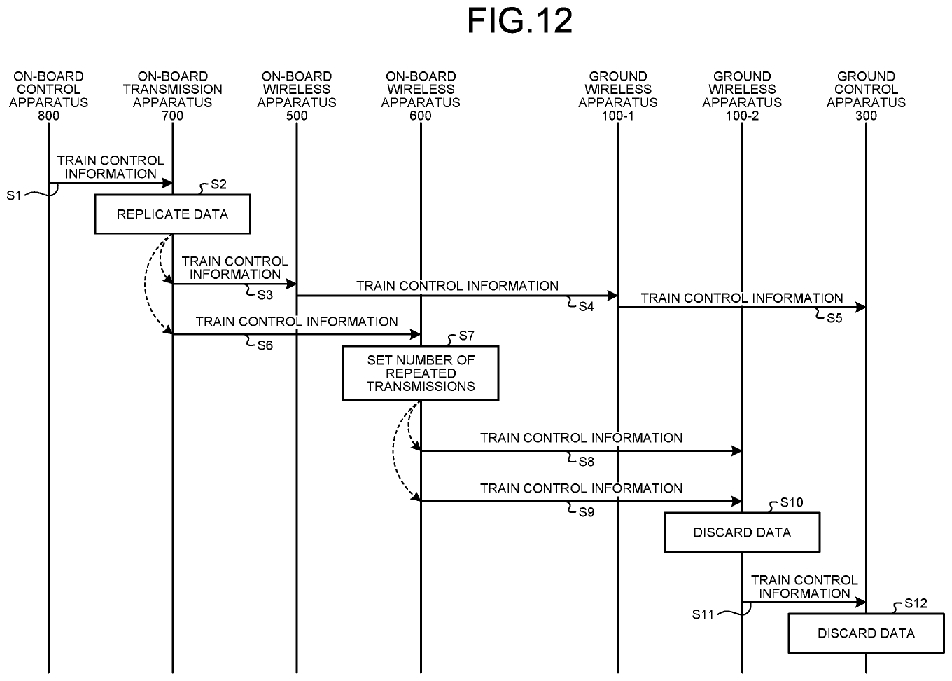

FIG. 12 is a diagram illustrating an example of a transmission sequence in which train control information is transmitted from the on-board control apparatus 800 to the ground control apparatus 300. As illustrated in FIG. 12, first, the on-board control apparatus 800 generates train control information and transmits the train control information to the on-board transmission apparatus 700 (Step S1). Upon receiving data, that is, the train control information via the control apparatus connection unit 710, the transmission data replication unit 712 of the on-board transmission apparatus 700 replicates the train control information (Step S2). The replicated train control information is transmitted to each of the on-board wireless apparatuses 500 and 600 via the wireless apparatus connection unit 713 (Steps S3 and S6).

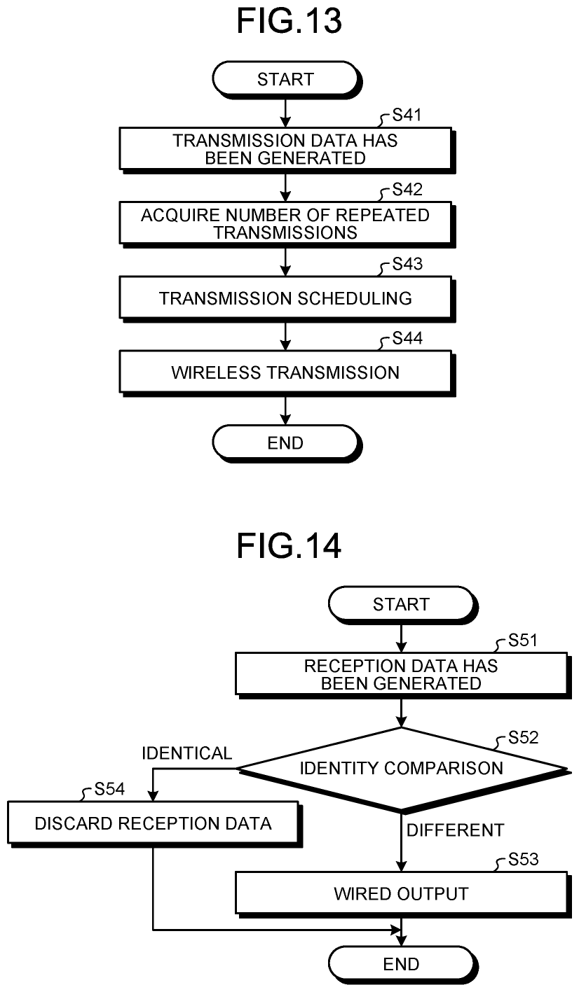

The on-board wireless apparatus 500 transmits the received train control information to the ground wireless apparatus 100-1 via the antenna 501 (Step S4). Details of the process in Step S4 will be described with reference to FIG. 13. FIG. 13 is a flowchart illustrating an example of a transmission processing procedure in the ground wireless apparatuses 100 and the on-board wireless apparatuses 500 and 600 of the present embodiment. Here, the flowchart illustrated in FIG. 13 will be described taking the on-board wireless apparatus 500 as an example. The wireless control unit 513 of the on-board wireless apparatus 500 receives the train control information from the wired control unit 514, and thereby the wireless control unit 513 determines that transmission data has been generated (Step S41). The wireless control unit 513 notifies the transmission frequency setting unit 515 that transmission data has been generated. The transmission frequency setting unit 515 acquires the number of repetitions, that is, the number of repeated transmissions (Step S42). Specifically, the transmission frequency setting unit 515 determines the number of repetitions using the ID of the on-board wireless apparatus 500, the first table, and the second table. The transmission frequency setting unit 515 notifies the wireless control unit 513 of the acquired number of repeated transmissions.

The wireless control unit 513 performs transmission scheduling on the basis of the number of repeated transmissions (Step S43). Specifically, as described above, the wireless control unit 513 selects slots the number of which is corresponding to the number of repeated transmissions from the available slots, and performs scheduling so as to transmit the train control information in the selected slot. On the basis of the control from the wireless control unit 513 and in accordance with the transmission scheduling, the wireless transmission unit 511 of the on-board wireless apparatus 500 wirelessly transmits the train control information, that is, transmits the train control information as a wireless signal via the antenna 501 (Step S44), and ends the transmission process. In the above, the description has been given taking the on-board wireless apparatus 500 as an example, but a process similar to that of FIG. 13 is performed also in the on-board wireless apparatus 600, although the antenna to be connected is different therefrom. A similar process is performed also in each of the ground wireless apparatuses 100, although there are the following differences. The antenna to be connected is different, and the ID used when acquiring the number of repetitions in Step S42 is an ID of an on-board wireless apparatus as a communication counterpart. That is, operations similar to those of the wireless transmission unit 511, the wireless control unit 513, the wired control unit 514, and the transmission frequency setting unit 515 described above are performed by the wireless transmission unit 111, the wireless control unit 113, the wired control unit 114, and the transmission frequency setting unit 115, respectively.

Returning to the description of FIG. 12, since the number of repetitions in the on-board wireless apparatus 500 is determined to be one, in the example illustrated in FIG. 12, the train control information is transmitted one time, that is, in one slot in Step S4. Upon receiving the train control information from the on-board wireless apparatus 500, the ground wireless apparatus 100-1 determines whether to discard the received train control information. FIG. 14 is a flowchart illustrating an example of a reception processing procedure in the ground wireless apparatuses 100 and the on-board wireless apparatuses 500 and 600 of the present embodiment. Here, the flowchart illustrated in FIG. 14 will be described taking the ground wireless apparatus 100 as an example. When the wireless control unit 113 of the ground wireless apparatus 100 receives data from the wireless reception unit 110, and thereby the wireless control unit 113 determines that reception data has been generated (Step S51), the wireless control unit 113 performs identity comparison (Step S52). Specifically, the wireless control unit 113 determines whether there is data identical with the reception data among data received in the past. For the identity comparison, the wireless control unit 113 stores a sequence number included in the reception data, or stores the reception data for a fixed period or stores a fixed number of reception data.

When the wireless control unit 113 determines as a result of the identity comparison that the reception data is different (Step S52, different), that is, when the wireless control unit 113 determines that there is no data received in the past which is identical with the reception data, the wireless control unit 113 transmits the reception data via the wired control unit 114 and the wired connection unit 112 (Step S53), and ends the reception process. In FIG. 14, wired transmission via the wired control unit 114 and the wired connection unit 112 is abbreviated as wired output.

When the wireless control unit 113 determines as a result of the identity comparison that the reception data is identical (Step S52, identical), that is, when the wireless control unit 113 determines that there is data received in the past which is identical with the reception data, the wireless control unit 113 discards the reception data (Step S54), and ends the reception process.

Also when the on-board wireless apparatuses 500 and 600 receive data from the ground wireless apparatuses 100, a process similar to that of FIG. 14 is performed. That is, operations of the wireless reception unit 110, the wireless control unit 113, the wired control unit 114, and the wired connection unit 112 are performed by the wireless reception unit 510, the wireless control unit 513, the wired control unit 514, and the wired connection unit 512, respectively. In addition, also when the on-board transmission apparatus 700 receives data from the on-board wireless apparatuses 500 and 600, the reception data selection unit 711 performs the identity comparison on the reception data, and when the reception data is determined to be identical, the reception data selection unit 711 discards the reception data. The identity comparison is performed on the reception data also in the ground control apparatus 300, and when the reception data is determined to be identical, the reception data is discarded.

Returning to the description of FIG. 12, after Step S4, the process illustrated in FIG. 14 is performed in the ground wireless apparatus 100-1. In such a case, the reception data, that is, the train control information has been transmitted only one time, and therefore, the reception data is transmitted to the ground control apparatus 300 without being discarded (Step S5).

On the other hand, when the on-board wireless apparatus 600 acquires the train control information transmitted in Step S6, the on-board wireless apparatus 600 sets the number of repeated transmissions to two by the process illustrated in FIG. 13 (Step S7). As a result, the train control information is transmitted in two slots in one frame (Steps S8 and S9).

Upon receiving the train control information transmitted in Step S8 from the on-board wireless apparatus 600, the ground wireless apparatus 100-2 performs the process illustrated in FIG. 14. In such a case, it is a first transmission for the reception data, that is, the train control information, and therefore, the reception data is transmitted to the ground control apparatus 300 without being discarded (Step S11). Upon receiving the train control information transmitted in Step S9 from the on-board wireless apparatus 600, the ground wireless apparatus 100-2 performs the process illustrated in FIG. 14. In such a case, it is a second transmission for the reception data, that is, the train control information, and therefore, the reception data is discarded (Step S10). Because the ground control apparatus 300 has already received the train control information transmitted in Step S11 via the on-board wireless apparatus 500, the ground control apparatus 300 discards the data transmitted in Step S11 (Step S12).

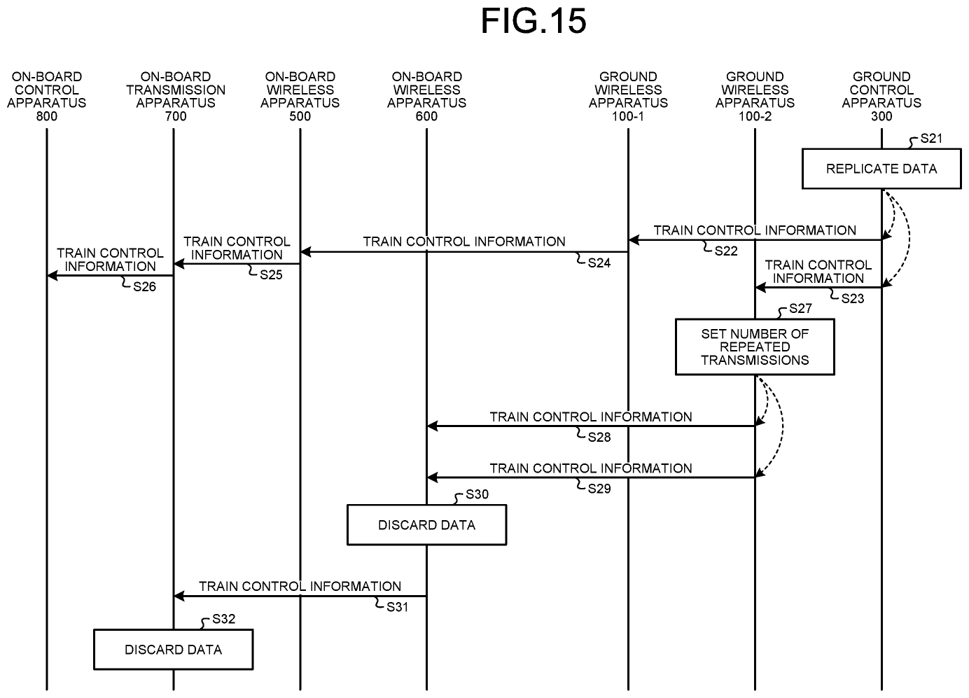

FIG. 15 is a diagram illustrating an example of a transmission sequence in which train control information is transmitted from the ground control apparatus 300 to the on-board control apparatus 800. As illustrated in FIG. 15, upon generating the train control information, the ground control apparatus 300 replicates the generated train control information (Step S21), and transmits the train control information to the ground wireless apparatuses 100-1 and 100-2 (Steps S22 and S23). Thus, the ground control apparatus 300 replicates the train control information and transmits the train control information to the plurality of ground wireless apparatuses 100.

In accordance with the process illustrated in FIG. 13, the ground wireless apparatus 100-1 determines that the number of repeated transmissions is one, and transmits the train control information to the on-board wireless apparatus 500 (Step S24). In accordance with the process illustrated in FIG. 14, the on-board wireless apparatus 500 transmits the received train control information to the on-board transmission apparatus 700 without discarding the train control information (Step S25). The on-board transmission apparatus 700 transmits the received train control information to the on-board control apparatus 800 (Step S26).

In accordance with the process illustrated in FIG. 13, the ground wireless apparatus 100-2 determines that the number of repeated transmissions is two (Step S27), replicates the train control information, and transmits the train control information to the on-board wireless apparatus 600 in two slots in one frame (Steps S28 and S29).

Upon receiving the train control information transmitted in Step S28 from the ground wireless apparatus 100-2, the on-board wireless apparatus 600 performs the process illustrated in FIG. 14. In such a case, it is a first transmission for the reception data, that is, the train control information, and therefore, the reception data is transmitted to the on-board transmission apparatus 700 without being discarded (Step S31). Upon receiving the train control information transmitted in Step S29 from the ground wireless apparatus 100-2, the on-board wireless apparatus 600 performs the process illustrated in FIG. 14. In such a case, it is a second transmission for the reception data, that is, the train control information, and therefore, the reception data is discarded (Step S30). The reception data selection unit 711 of the on-board transmission apparatus 700 performs the process illustrated in FIG. 14. Because the on-board transmission apparatus 700 has already received the train control information transmitted in Step S31 via the on-board wireless apparatus 500, the on-board transmission apparatus 700 discards the train control information transmitted in Step S31 (Step S32).

The transmission/reception processes of the train control information between the ground wireless apparatuses 100 and the on-board wireless apparatuses 500 and 600 described above are on the basis of the premise that all the transmitted data are successfully received. However, on the roof of each vehicle of the train 400, structures such as the air conditioner 411 and the pantograph 412 are installed. In a propagation path between the antenna 601 installed on the roof of the vehicle 401 and the antenna 102-2 connected to the ground wireless apparatus 100-2, these structures serve as shielding objects for radio wave propagation, and all data cannot necessarily be transmitted and received. In the transmission/reception processes between the grounded wireless apparatuses 100 and the on-board wireless apparatuses 500 and 600 described above, the different number of repeated transmissions is selected for each on-board wireless apparatus depending on the antenna installation location and antenna directionality. Therefore, when the number of repeated transmissions is set to be more than one, it is satisfactory that at least one of the data transmitted in one frame is received, so that improvement of a reach rate of the train control information can be expected even when in a poor radio wave propagation environment.

When both the tail vehicle and the lead vehicle of the train 400 include ground apparatuses in the wireless train control system 1000 of the present embodiment mounted on the lead vehicle illustrated in FIG. 2, operations similar to those in the present embodiment can be realized even when the cab of the train 400 is switched, that is, the lead vehicle and the tail vehicle are switched.

As described above, in the present embodiment, the same vehicle includes a plurality of antennas and a plurality of on-board wireless apparatuses, and the number of repeated transmissions is set for each antenna. For this reason, even when a wireless signal attenuates due to a structure or the like between the ground wireless apparatuses 100 and the on-board wireless apparatuses 500 and 600, it is possible to improve reliability of wireless communication by increasing the number of repeated transmissions in one frame. In addition, by installing a plurality of wireless apparatuses in one train consist on the same vehicle, it is possible to secure a plurality of transmission paths with the ground wireless apparatuses 100 without using a through cable between the vehicles. Since the through cable between the vehicles is not used, weight reduction and cost reduction of the vehicle can be achieved. In addition, when a large number of vehicles are used for constituting one train consist, that is, when train consist length is long, a transmission delay between the on-board wireless apparatuses can be reduced as compared with a method in which an on-board wireless apparatus is installed on each of a lead vehicle and a tail vehicle of the one train consist, and wired connection is established therebetween using a through cable.

In the example described above, the number of transmissions in the same frame, that is, the number of time slots used for transmission in the frame is used as the number of duplicated data transmissions. However, a similar effect can be obtained also by using, as the number of transmissions of replicated data, a frequency channel instead of the number of time slots in the same frame. That is, instead of the number of repeated transmissions, the number of frequency channels to be used may be set for each antenna in the second table. Alternatively, instead of the number of time slots used for transmission in the frame, a modulation scheme of wireless communication may be set to a different value for each on-board wireless apparatus. That is, instead of the number of repeated transmissions, a modulation scheme to be applied to data to be transmitted may be determined in the second table. In such a case, an effect similar to that of the present embodiment can be obtained, for example, by setting the modulation scheme used in the on-board wireless apparatus 600 to be higher in noise resistance than the modulation scheme used in the on-board wireless apparatus 500.

In the above, the example has been described in which two sets of antennas and on-board wireless apparatuses connected to the antennas are installed on the same vehicle. However, three or more sets of antennas and on-board wireless apparatuses connected to the antennas may be installed on the same vehicle. Also in such a case, similarly to the above example, it is satisfactory as long as the reliabilities in the transmission paths using the antennas of the respective sets are set to be different from each other.

The example has been described in which antenna information is used as a parameter indicating reliability of wireless communication. However, the number of repeated transmissions may be used as the parameter indicating reliability of wireless communication.

### Second Embodiment

In the first embodiment, description has been given on the premise that the first table and the second table are set in advance in each apparatus. In the second embodiment, description will be given for a method of notifying information on an antenna type from on-board wireless apparatuses to ground wireless apparatuses in a procedure for connecting a wireless link. According to this method, it is unnecessary to set the first table in the ground wireless apparatuses in advance. A configuration of the wireless train control system of the present embodiment and a configuration of each apparatus constituting the wireless train system are the same as those of the first embodiment. Hereinafter, differences from the first embodiment will be mainly described, and overlapping descriptions of those described in the first embodiment will be omitted.

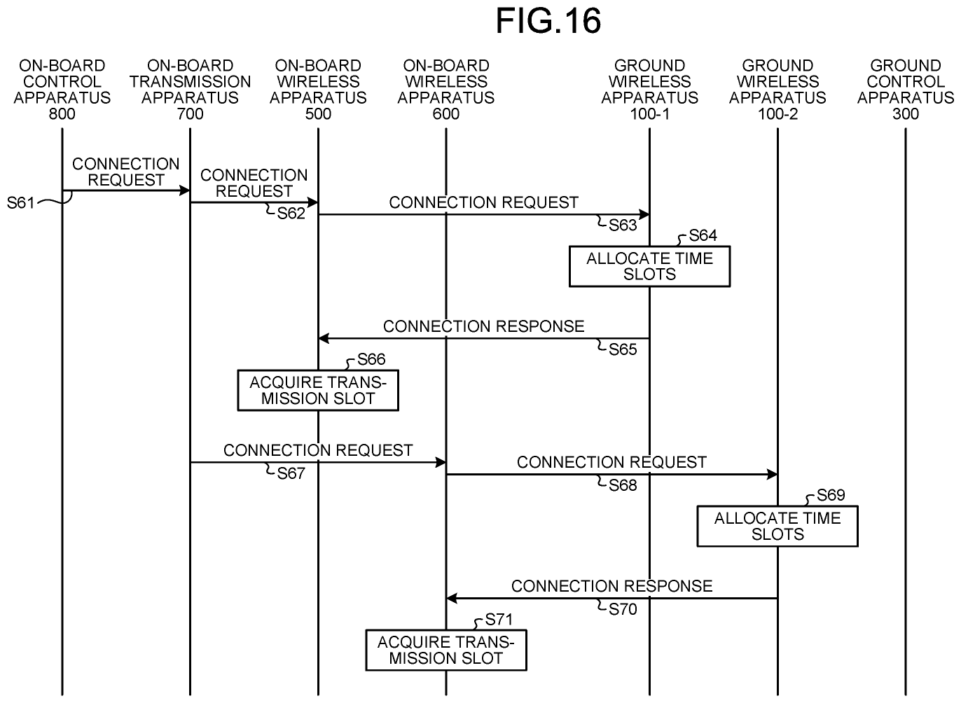

FIG. 16 is a sequence diagram illustrating an example of a procedure for connecting a wireless link from the on-board wireless apparatuses 500 and 600 to the ground wireless apparatuses 100 of the present embodiment. As illustrated in FIG. 16, when transmission of train control information is started with start of the wireless train control, the on-board control apparatus 800 transmits a connection request to the on-board transmission apparatus 700 (Step S61). The on-board transmission apparatus 700 replicates the received connection request and transmits the connection request to each of the on-board wireless apparatus 500 and the on-board wireless apparatus 600 (Steps S62 and S67). Specifically, when the transmission data replication unit 712 of the on-board transmission apparatus 700 receives the connection request via the control apparatus connection unit 710, the transmission data replication unit 712 replicates the connection request and outputs two connection requests to the wireless apparatus connection unit 713. The wireless apparatus connection unit 713 transmits the two connection requests, one to the on-board wireless apparatus 500 and the other to the on-board wireless apparatus 600.

The on-board wireless apparatus 500 transmits a connection request message to the ground wireless apparatus 100 via the antenna 501. Particularly, upon receiving the connection request via the wired connection unit 512 and the wired control unit 514, the wireless control unit 513 of the on-board wireless apparatus 500 generates the connection request message, and transmits the connection request message via the wireless transmission unit 511 and the antenna 501 (Step S63). Here, it is assumed that the train 400 is located at the position illustrated in FIG. 1 of the first embodiment, and the connection request message transmitted from the on-board wireless apparatus 500 is received by the ground wireless apparatus 100-1 via the antenna 101-1. The connection request message transmitted from the on-board wireless apparatus 500 includes the content of the connection request received by the on-board wireless apparatus 500 and information on an installation location and antenna directionality of the antenna 501 to which the on-board wireless apparatus 500 is connected. In the on-board wireless apparatus 500, information on the installation location and the antenna directionality of the antenna 501 to which the on-board wireless apparatus 500 is connected is set.

The ground wireless apparatus 100-1 does not store the first table described in the first embodiment, but stores the second table. On the basis of the information on the installation location and the antenna directionality of the antenna 501 included in the connection request message, and the second table, the ground wireless apparatus 100-1 allocates time slots for communication with the on-board wireless apparatus 500 (Step S64). Here, it is assumed that the second table is the one illustrated in FIG. 10, and the installation locations and the directionalities of the antennas 501 and 601 are the same as those in the first embodiment. Because the installation location of the antenna 501 is the inside of the vehicle and the antenna directionality thereof is forward, the transmission frequency setting unit 115 of the ground wireless apparatus 100-1 refers to the second table to determine the number of repeated transmissions corresponding to the on-board wireless apparatus 500 to be one, and notifies the wireless control unit 113 of the determined number of repeated transmissions. Then, the wireless control unit 113 of the ground wireless apparatus 100-1 allocates slot 3 to the transmission from the on-board side to the ground side and allocates slot 8 to the transmission from the ground side to the on-board side from among available time slots.

The wireless control unit 113 of the ground wireless apparatus 100-1 generates a connection response message including a result of the time slot allocation, and transmits the connection response message to the on-board wireless apparatus 500 via the wireless transmission unit 111 and the antenna 101-1 (Step S65). Upon receiving the connection response message via the antenna 501 and the wireless reception unit 510, the wireless control unit 513 of the on-board wireless apparatus 500 extracts the result of the time slot allocation from the connection response message, thereby acquiring Information indicating a time slot to be used for transmission from the on-board wireless apparatus 500, that is, a transmission slot (Step S66). Thereafter, the on-board wireless apparatus 500 transmits the train control information using slot 3 in one frame according to the result of the time slot allocation.

Similarly, the on-board wireless apparatus 600 transmits a connection request message including information on an installation location and antenna directionality of the antenna 601 to the ground wireless apparatus 100-2 (Step S68). Similarly to the ground wireless apparatus 100-1, the ground wireless apparatus 100-2 determines the number of repeated transmissions on the basis of the information on the installation location and the antenna directionality of the antenna 601 and the second table, and allocates time slots to communication with the on-board wireless apparatus 600 (Step S69). In such a case, the antenna 601 is installed on the roof and the antenna orientation direction is the rearward direction, and therefore, the number of repetitions is determined to be two. Therefore, similarly to the example of FIG. 11, for example, the ground wireless apparatus 100-2 allocates slots 2 and 4 to the transmission from the on-board side to the ground side and allocates slots 7 and 9 to the transmission from the ground side to the on-board side from among available time slots. Similarly to the ground wireless apparatus 100-1, the ground wireless apparatus 100-2 generates a connection response message including a result of the time slot allocation, and transmits the connection response message to the on-board wireless apparatus 600 (Step S70). As a result, the on-board wireless apparatus 600 acquires information indicating a time slot to be used for transmission from the on-board wireless apparatus 600, that is, a transmission slot (Step S71). Thereafter, the on-board wireless apparatus 600 transmits the train control information using slot 3 in one frame according to the result of the time slot allocation. Because operations in the wireless train control system 1000 after time slots have been allocated are similar to those in the first embodiment, descriptions thereof will be omitted.

As described above, in the present embodiment, the information on the antenna type is notified from the on-board wireless apparatuses 500 and 600 to the ground wireless apparatuses 100 in the procedure for connecting a wireless link. That is, the ground wireless apparatuses 100 acquire the information in the process of connecting a wireless link with each of the on-board wireless apparatus 500 and the on-board wireless apparatus 600. For this reason, an effect similar to that of the first embodiment is obtained, and it is unnecessary to register information on the antennas connected to the on-board wireless apparatuses 500 and 600 in advance in the ground wireless apparatuses 100.

The configurations described in the embodiments above are merely examples of the content of the present invention and can be combined with other known technology and part thereof can be omitted or modified without departing from the gist of the present invention.

### REFERENCE SIGNS LIST

100, 100-1, 100-2 ground wireless apparatus; 101-1, 101-2, 102-1, 102-2, 501, 601 antenna; 110, 510 wireless reception unit; 111, 511 wireless transmission unit; 112, 512 wired connection unit; 113, 513 wireless control unit; 114, 514 wired control unit; 115, 515 transmission frequency setting unit; 300 ground control apparatus; 400 train; 401 to 404 vehicle; 500, 600 on-board wireless apparatus; 700 on-board transmission apparatus; 710 control apparatus connection unit; 711 reception data selection unit; 712 transmission data replication unit; 713 wireless apparatus connection unit; 800 on-board control apparatus.

1-16. (canceled)

17. An on-board wireless system comprising:
in one of vehicles constituting a train, a first on-board wireless transceiver connected to a first antenna that orients a travel direction of the train, and to communicate with a first ground wireless transceiver that is one of ground wireless transceivers that have been installed; and
a second on-board wireless transceiver connected to a second antenna whose orientation direction is different from that of the first antenna and that orients a direction opposite to the travel direction of the train, and to communicate with the ground wireless transceiver different from the first ground wireless transceiver.

18. The on-board wireless system according to claim 17, further comprising:
an on-board transmitter wiredly connected to the first on-board wireless transceiver and the second on-board wireless transceiver, and to transmit data to the ground wireless transceiver via the first on-board wireless transceiver and the second on-board wireless transceiver.

19. The on-board wireless system according to claim 17, wherein
a number of duplicated data transmissions performed by each of the first on-board wireless transceiver and the second on-board wireless transceiver is determined on a basis of a parameter indicating reliability in corresponding wireless communication.

20. The on-board wireless system according to claim 18, wherein
a number of duplicated data transmissions performed by each of the first on-board wireless transceiver and the second on-board wireless transceiver is determined on a basis of a parameter indicating reliability in corresponding wireless communication.

21. The on-board wireless system according to claim 19, wherein
the parameter is on a basis of an antenna gain or an installation location of each of the first antenna and the second antenna.

22. The on-board wireless system according to claim 20, wherein
the parameter is on a basis of an antenna gain or an installation location of each of the first antenna and the second antenna.
